(19) United States
(12) Patent Application Publication
(10) Pub. No.: US 2014/0201200 A1
(43) Pub. Date: Jul. 17, 2014

(54) VISUAL SEARCH ACCURACY WITH HAMMING DISTANCE ORDER STATISTICS LEARNING

(71) Applicant: Samsung Electronics Co., Ltd., Suwon-si (KR)

(72) Inventors: Zhu Li, Plano, TX (US); Abhishek Nagar, Garland, TX (US); Kong Posh Bhat, Plano, TX (US); Xin Xin, Bellevue, WA (US); Gaurav Srivastava, Dallas, TX (US); Felix Carlos Fernandes, Plano, TX (US)

(73) Assignee: Samsung Electronics Co., Ltd., Suwon-si (KR)

(21) Appl. No.: 14/153,907

(22) Filed: Jan. 13, 2014

Related U.S. Application Data
(60) Provisional application No. 61/753,292, filed on Jan. 16, 2013.

(51) Int. Cl. G06F 17/30

(52) U.S. Cl. CPC G06F 17/30277
USPC 707/723; 707/752

(57) ABSTRACT

Global descriptors for images within an image repository accessible to a visual search server are compared based on order statistics processing including sorting (which is a non-linear transform) and heat kernel matching. Affinity scores are computed for Hamming distances between Fisher vector components corresponding to different clusters of global descriptors from a pair of images and normalized to [0, 1], with zero affinity scores assigned to non-active cluster pairs. Linear Discriminant Analysis is employed to determine a sorted vector of affinity scores to obtain a new global descriptor. The resulting global descriptors produce significantly more accurate matching.

This application claims priority to and hereby incorporates by reference U.S. Provisional Patent Application No. 61/753,292, filed Jan. 16, 2013, entitled “VISUAL SEARCH ACCURACY WITH HAMMING DISTANCE ORDER STATISTICS LEARNING.”

### TECHNICAL FIELD

The present disclosure relates generally to image matching during processing of visual search requests and, more specifically, to reducing computational complexity and communication overhead associated with a visual search request submitted over a wireless communications system.

### BACKGROUND

Mobile visual search and Augmented Reality (AR) applications are gaining popularity recently with important business values for a variety of players in mobile computing and communication fields. However, some approaches to defining search indices, such as use of Fisher vectors, are susceptible to noise, and the distance between two Fisher vector indices is easily dominated by noisy clusters associated with the indices. In addition, heuristic thresholding for search index definition without a proper problem formulation offers at best sub-optimal solutions.

There is, therefore, a need in the art for effective selection of indices used for visual search request processing.

### SUMMARY

Global descriptors for images within an image repository accessible to a visual search server are compared based on order statistics processing including sorting (which is a non-linear transform) and heat kernel-based transformation. Affinity scores are computed for Hamming distances between Fisher vector components corresponding to different clusters of global descriptors from a pair of images and normalized to [0, 1], with zero affinity scores assigned to non-active cluster pairs. Linear Discriminant Analysis is employed to determine a sorted vector of affinity scores to obtain a new global descriptor. The resulting global descriptors produce significantly more accurate matching.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, where such a device, system or part may be implemented in hardware that is programmable by firmware or software. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a high level diagram illustrating an exemplary wireless communication system within which global descriptors obtained using order statistics may be employed for visual query processing in accordance with various embodiments of the present disclosure;

FIG. 1A is a high level block diagram of the functional components of the visual search server from the network of FIG. 1;

FIG. 1B is a front view of wireless device from the network of FIG. 1;

FIG. 1C is a high level block diagram of the functional components of the wireless device of FIG. 1B;

FIG. 2 illustrates, at a high level, the overall compact descriptor visual search pipeline exploited within a visual search server employing global descriptors obtained using order statistics in accordance with embodiments of the present disclosure;

FIGS. 3A and 3B illustrate Hamming distances for matching and non-matching image pairs, respectively, computed as part of global descriptor extraction in accordance with embodiments of the present disclosure;

FIGS. 4A and 4B illustrate 32 dimension affinity features of the images of FIGS. 3A and 3B, respectively, exploited as part of global descriptor clustering in accordance with embodiments of the present disclosure;

FIG. 5 illustrates optimal weights to be ascribed to affinity scores determined from FIGS. 4A and 4B using Linear Discriminant Analysis;

FIG. 6 illustrates comparatively plotted precision-recall performance using the original global descriptors obtained using heuristic thresholding, using 32 dimension affinity scoring with Linear Discriminant Analysis, and using 64 dimension affinity scoring with Linear Discriminant Analysis; and

FIG. 7 is a high level flow diagram for processing of a visual search query using global descriptors obtained based upon order statistics in accordance with embodiments of the present disclosure.

### DETAILED DESCRIPTION

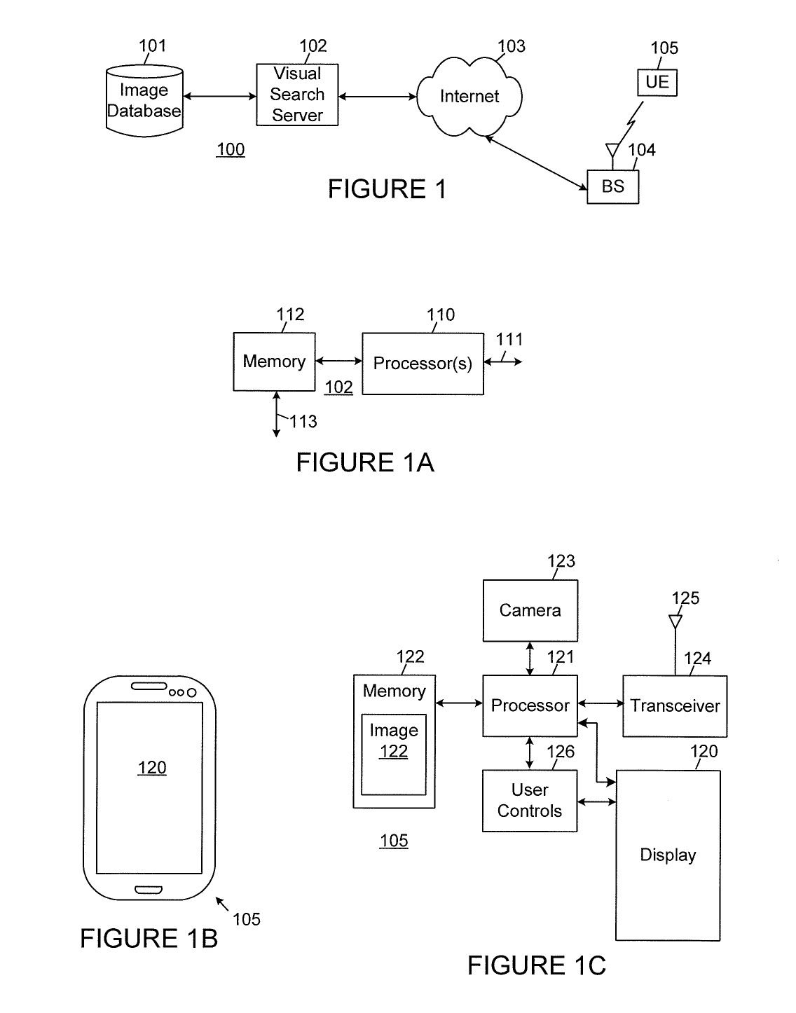

FIGS. 1 through 7, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system.

The following documents and standards descriptions are hereby incorporated into the present disclosure as if fully set forth herein:
[REF1]—Test Model 3: Compact Descriptor for Visual Search, ISO/IEC/JTC1/SC29/WG11/W12929, Stockholm, Sweden, July 2012;
[REF2]—CDVS, Description of Core Experiments on Compact descriptors for Visual Search, N12551, San Jose, Calif., USA: ISO/IEC JTC1/SC29/WG11, February 2012;
[REF3]—CDVS, Evaluation Framework for Compact Descriptors for Visual Search, N12202, Turin, Italy: ISO/IEC JTC1/SC29/WG11, 2011;
[REF4]—CDVS Improvements to the Test Model Under Consideration with a Global Descriptor, M23938, San Jose, Calif., USA: ISO/IEC JTC1/SC29/WG11, February 2012;
[REF5]—IETF RFC5053, Raptor Forward Error Correction Scheme for Object Delivery;
[REF6]—Lowe, D. (2004), Distinctive Image Features from Scale-Invariant Keypoints, International Journal of Computer Vision, 60, 91-110; and

### [REF7]—Andrea Vedaldi, Brian Fulkerson: “Vlfeat: An Open and Portable Library of Computer Vision Algorithms,” ACM Multimedia 2010: 1469-1472.

Mobile visual search using Content Based Image Recognition (CBIR) and Augmented Reality (AR) applications are gaining popularity, with important business values for a variety of players in the mobile computing and communication fields. One key technology enabling such applications is a compact image descriptor that is robust to image recapturing variations and efficient for indexing and query transmission over the air. As part of on-going Motion Picture Expert Group (MPEG) standardization efforts, definitions for Compact Descriptors for Visual Search (CDVS) are being promulgated (see [REF1] and [REF2]).

FIG. 1 is a high level diagram illustrating an exemplary network within which global descriptors obtained using order statistics may be employed for visual query processing in accordance with various embodiments of the present disclosure. The network 100 includes a database 101 of stored global descriptors regarding various images (which, as used herein, includes both still images and video), and possibly the images themselves. The images may relate to geographic features such as a building, bridge or mountain viewed from a particular perspective, human images including faces, or images of objects or articles such as a brand logo, a vegetable or fruit, or the like. The database 101 is communicably coupled to (or alternatively integrated with) a visual search server data processing system 102, which processes visual searches in the manner described below. The visual search server 102 is coupled by a communications network, such as the Internet 103 and a wireless communications system including a base station (BS) 104, for receipt of visual searches from and delivery of visual search results to a user device 105, which may also be referred to as user equipment (UE) or a mobile station (MS). As noted above, the user device 105 may be a “smart” phone or tablet device capable of functions other than wireless voice communications, including at least playing video content. Alternatively, the user device 105 may be a laptop computer or other wireless device having a camera or display and/or capable of requesting a visual search.

FIG. 1A is a high level block diagram of the functional components of the visual search server from the network of FIG. 1, while FIG. 1B is a front view of wireless device from the network of FIG. 1 and FIG. 1C is a high level block diagram of the functional components of that wireless device.

Visual search server 102 includes one or more processor(s) 110 coupled to a network connection 111 over which signals corresponding to visual search requests may be received and signals corresponding to visual search results may be selectively transmitted. The visual search server 102 also includes memory 112 containing an instruction sequence for processing visual search requests in the manner described below, and data used in the processing of visual search requests. The memory 112 in the example shown includes a communications interface for connection to image database 101.

User device 105 is a mobile phone and includes an optical sensor (not visible in the view of FIG. 1B) for capturing images and a display 120 on which captured images may be displayed. A processor 121 coupled to the display 120 controls content displayed on the display. The processor 121 and other components within the user device 105 are powered by a battery (not shown), which may be recharged by an external power source (also not shown), or alternatively may be powered by the external power source. A memory 122 coupled to the processor 121 may store or buffer image content for playback or display by the processor 121 and display on the display 120, and may also store an image display and/or video player application (or “app”) 122 for performing such playback or display. The image content being played or display may be captured using camera 123 (which includes the above-described optical sensor) or received, either contemporaneously (e.g., overlapping in time) with the playback or display or prior to the playback/display, via transceiver 124 connected to antenna 125—e.g., as a Short Message Service (SMS) “picture message.” User controls 126 (e.g., buttons or touch screen controls displayed on the display 120) are employed by the user to control the operation of mobile device 105 in accordance with known techniques.

In the exemplary embodiment, the image content within mobile device 105 is processed by processor 121 to generate visual search query image descriptor(s). Thus, for example, a user may capture an image of a landmark (such as a building) and cause the mobile device 105 to generate a visual search relating to the image. The visual search is then transmitted over the network 100 to the visual search server 102.

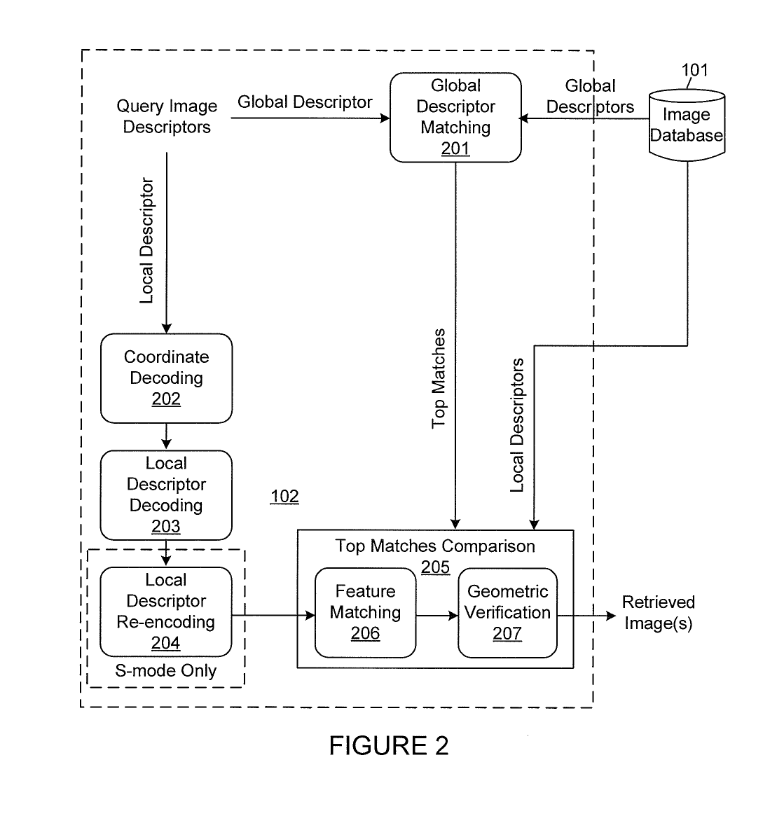

FIG. 2 illustrates, at a high level, the overall compact descriptor visual search pipeline exploited within a visual search server employing global descriptors obtained using order statistics in accordance with embodiments of the present disclosure. Rather than transmitting an entire image to the visual search server 102 for deriving a similarity measure between known images, the mobile device 105 transmits only descriptors of the image, which may include one or both of global descriptors such as the color histogram and texture and shape features extracted from the whole image and/or local descriptors, which are extracted using (for example) Scale Invariant Feature Transform (SIFT) or Speeded Up Robust Features (SURF) from feature points detected within the image and are preferably invariant to illumination, scale, rotation, affine and perspective transforms.

In a CDVS system, visual queries (VQ) typically consist of two parts: a global descriptor (GD) and a local descriptor (LD) and its associated coordinates. Local descriptors consists of a selection of SIFT [REF7] based local key point descriptors, compressed thru a multi-stage visual query scheme, and the global descriptor is derived from quantizing the Fisher Vector computed from up to 300 SIFT points, which basically captures the distribution of SIFT points in SIFT space. The local descriptor contributes to the accuracy of the image matching, while the global descriptor offers the crucial function of indexing efficiency and is used to compute a short list or potential matches from an image repository (a coarse granularity operation) for the local descriptor-based image verification of the short-listed images.

In the CDVS Test Model (TM), the global descriptor is computed from a quantized Fisher Vector of a pre-trained 128 cluster Gaussian mixture model (GMM) in the SIFT space, reduced by Principle Component Analysis (PCA) to 32 dimensions. As a result, 128×32 bits represent the Fisher Vectors from SIFT points in images. The distance between two global descriptors is computed based on the Hamming distance of common clusters, and a set of thresholds are applied for accepting or rejecting a match, according to the sum of active clusters in both images. As discussed above, however, such an approach is susceptible to noisy clusters in the global descriptor domain, and the distance is easily dominated by those noisy clusters. In addition, the heuristic thresholding without a proper problem formulation offers a sub-optimal solution.

To address those shortcomings, the visual query processing system described herein employs a novel order statistics based learning approach to find the optimal matching function and threshold, producing an improvement to the current state of art in the CDVS Test Model that is significant, as demonstrated by simulation results.

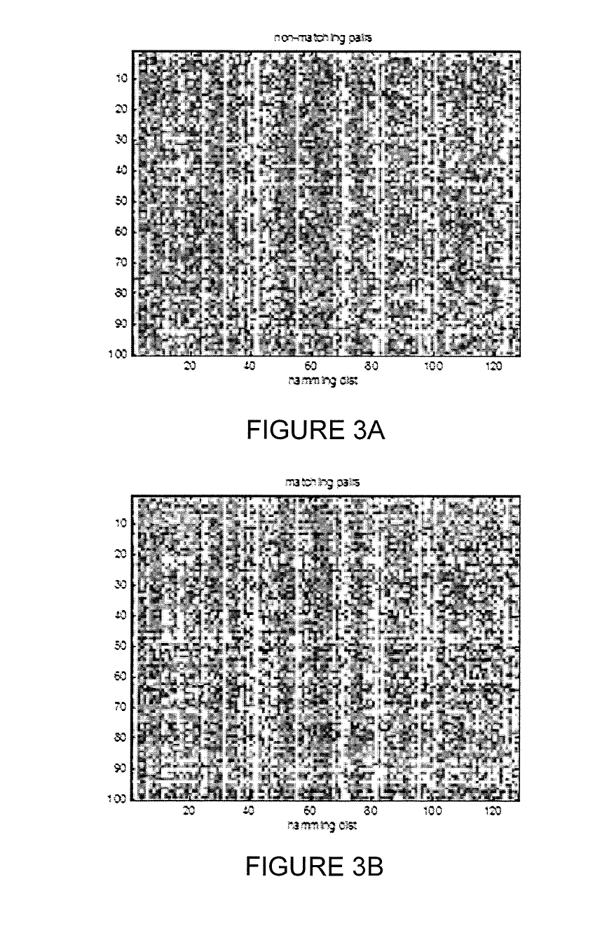

The global descriptors in the CDVS Test Model may represent each image in an image repository by a 32×128 binary matrix representing the Fisher Vectors for the SIFTs associated with an image. A 128 bit flag may also be included to indicate which GMM clusters are active in the global descriptor. The Hamming distance between two images may thus be computed with the following logic: Let two global descriptors X₁ and X₂ each be 128 32-bit vectors, X₁=[x₁¹, x₂¹, . . . , x₁₂₈¹] and X₂=[x₁², x₂², . . . , x₁₂₈²], with the respective associated flags F₁=[f₁¹, f₂¹, . . . , f₁₂₈¹] and F₁=[f₁¹, f₂¹, . . . , f₁₂₈¹]. The Hamming distance vector D between X₁ and X₂ is:

$${d}_{i} = \{ \begin{matrix}( {x}_{i}^{1} ⊕ {x}_{i}^{2} ) , & if ( {f}_{i}^{1} ⊕ {f}_{i}^{2} ) == 1 \\ ∞ , & else ,\end{matrix} \qquad ( 1 )$$

where ⊕ indicates the exclusive OR (XOR) operation. The Hamming distances for an example of 100 matching and non-matching image pairs are illustrated in the FIGS. 3A and 3B, respectively. In the approach described above for CDVS Test Model, a direct weighting and thresholding scheme is applied to decide image matches, a feature of the image-matching system that is apparently not optimized.

Order statistics is a known process in statistical data analysis. Accordingly, a sorting (which is a non-linear transformation) and heat kernel-based transformation may be introduced to operate on the Hamming distance features. First, the Hamming distance dᵢ computed for each cluster is sorted to obtain d₍₁₎, d₍₂₎, . . . , d₍ₖ₎. Then an affinity score rᵢ is computed as:

rᵢ=e^{-ad}^{₍ᵢ₎} (2)

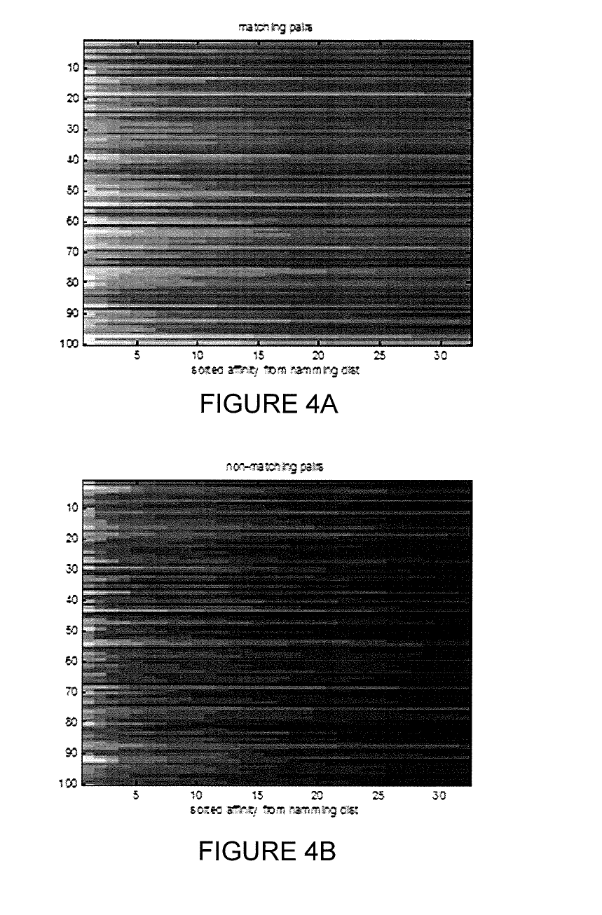

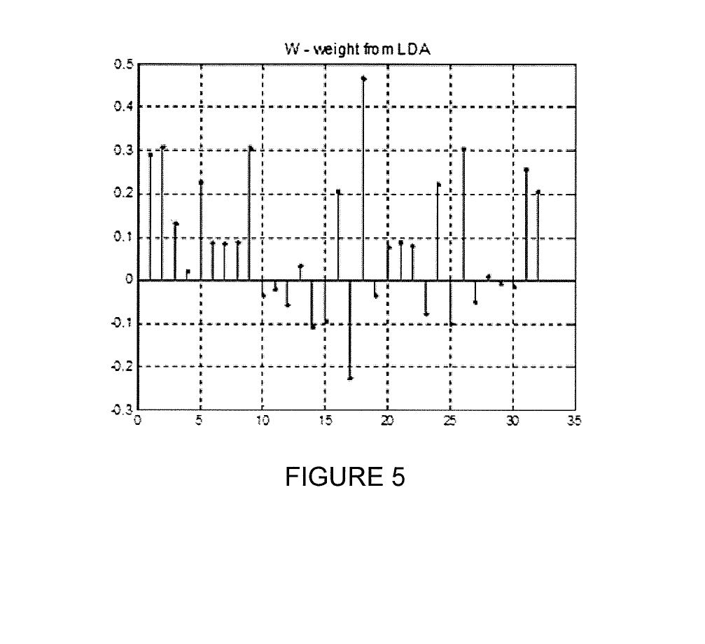

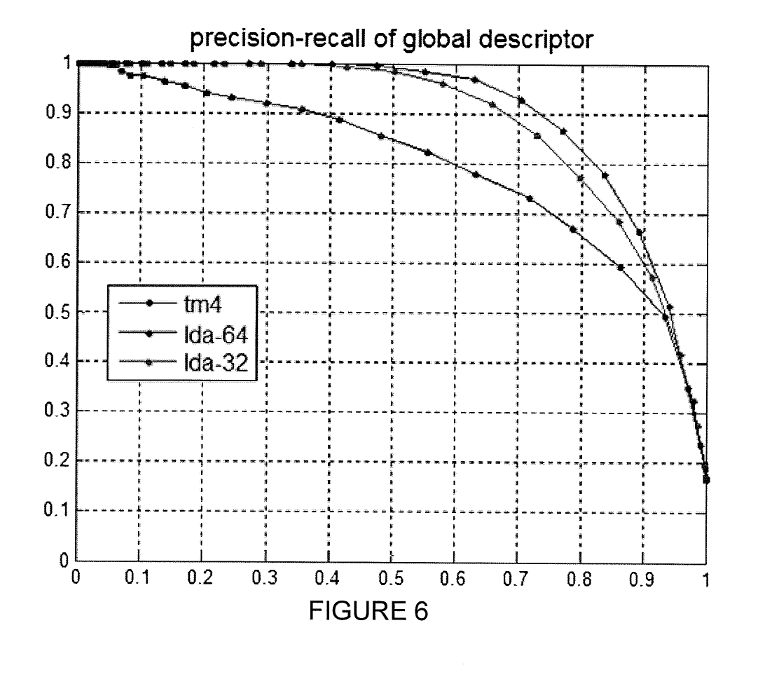

This normalizes the affinity per cluster in the global descriptors to [0, 1], assigns zero affinity to non-active cluster pairs, and resolves the irregular dimension size problem. Examples of 32 dimensional affinity feature from sorted Hamming distance, with kernel size a=0.1, are plotted in FIGS. 4A and 4B. It is clear that the affinity feature has more desired characteristics than the original Hamming distance, by having clear distinction between matching and non-matching pairs. To further exploit this new feature, a Linear Discriminant Analysis (LDA), pioneered by statistician R.A. Fisher and widely adopted in computer vision and especially in the Fisherface work for facial recognition, is applied to learn the most discriminant features from this input. The projection w for input affinity features {rᵢ} is obtained by maximizing:

$$J ( w ) = \frac{{w}^{T} {S}_{B} w}{{w}^{T} {S}_{W} w} , \qquad ( 3 )$$

where w^{T} is the transpose of w, S_{B} is the between-class covariance matrix, and S_{w} is the within-class covariance matrix. To solve equation (3), an eigen problem is computed. The optimal weights obtained from the Linear Discriminant Analysis are plotted in FIG. 5. The final precision-recall performance is computed against the ground truth from CDVS data set, for a randomly sampled subset consisting of 4000 positive and 20000 negative cases. The performance gains are plotted in FIG. 6 for affinity from the top 32 and 64 sorted Hamming distance features (the second topmost and topmost curves, respectively) with weighting by LDA as in equation (3), versus the alternative original thresholding approach described above (bottommost curve). As evident, significant gains are obtained from the 50% to ˜95% recall range. This approach is thus a powerful solution that can adapt well to global descriptors, including global descriptors at higher resolutions (dimensions) as well.

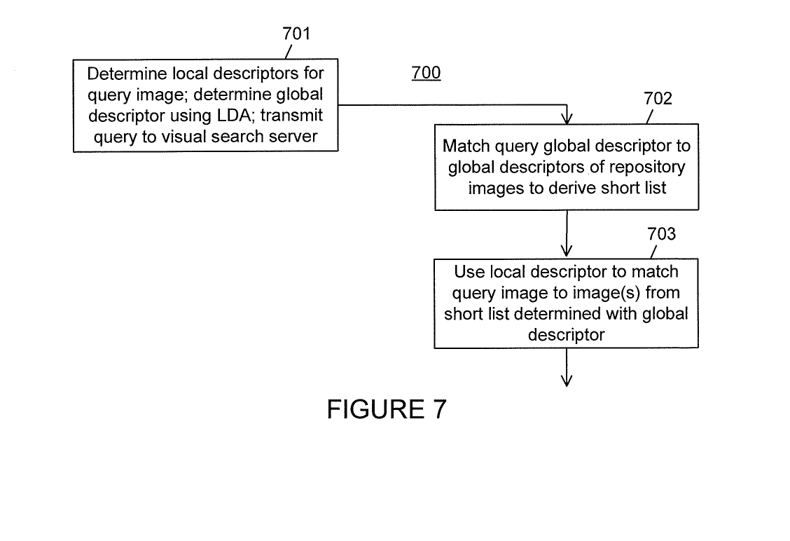

FIG. 7 is a high level flow diagram for processing of a visual search query using global descriptors obtained based upon order statistics in accordance with embodiments of the present disclosure. The exemplary process 700 depicted is performed partially (steps on the right side) in the processor 110 of the visual search server 102 and partially (steps on the left side) in the processor 121 of the client mobile handset 105. While the exemplary process flow depicted in FIG. 7 and described below involves a sequence of steps, signals and/or events, occurring either in series or in tandem, unless explicitly stated or otherwise self-evident (e.g., a signal cannot be received before being transmitted), no inference should be drawn regarding specific order of performance of steps or occurrence of the signals or events, performance of steps or portions thereof or occurrence of signals or events serially rather than concurrently or in an overlapping manner, or performance of the steps or occurrence of the signals or events depicted exclusively without the occurrence of intervening or intermediate steps, signals or events. Moreover, those skilled in the art will recognize that complete processes and signal or event sequences are not illustrated in FIG. 7 or described herein. Instead, for simplicity and clarity, only so much of the respective processes and signal or event sequences as is unique to the present disclosure or necessary for an understanding of the present disclosure is depicted and described.

In exploiting the improved precision-recall performance discussed above, the algorithm 700 operates as follows: First, local descriptors are determined for a query image utilizing known techniques. The global descriptor is then obtained using the affinity scores and Linear Discriminant Analysis as described above, and is transmitted along with the local descriptors (and possibly certain additional information) to the visual search server 102 as part of the visual search query (step 701). The global descriptor from the query is then compared to global descriptors for images within the image repository 101 (step 702). The resulting short list of images from the image repository, selected based on matching of the global descriptor from the query to the image global descriptors for images within the image repository, are then compared using the local descriptor from the query and local descriptors for the short list images (step 703). Correct matching is expected to improve and false positives are expected to reduce using this process.

The technical benefits of the more sophisticated learning algorithm described above include significantly improved matching accuracy.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method, comprising:
receiving, at a visual search server, information relating to a global descriptor for a query image for a visual search request; and
determining, at a visual search server, one or more sets of stored image information in which a global descriptor for a respective image corresponds to the global descriptor for the query image,
wherein the global descriptor for the query image is obtained based on processing including sorting and heat kernel-based transformation.

2. The method according to claim 1, wherein the global descriptor for the query image is obtained based on affinity scores computed from sorted Hamming distances for cluster pairs.

3. The method according to claim 2, wherein the affinity scores are normalized to [0, 1].

4. The method according to claim 2, wherein affinity scores of 0 are assigned to non-active cluster pairs.

5. The method according to claim 2, wherein Linear Discriminant Analysis is employed to determine a sorted vector of the affinity scores used to obtain the global descriptor for the query image.

6. A visual search server, comprising:
a network connection configured to receive information relating to a global descriptor for a query image for a visual search request; and
a processor configured to determine one or more sets of stored image information in which a global descriptor for a respective image corresponds to the global descriptor for the query image,
wherein the global descriptor for the query image is obtained based on processing including sorting and heat kernel-based transformation.

7. The visual search server according to claim 6, wherein the global descriptor for the query image is obtained based on affinity scores computed from sorted Hamming distances for cluster pairs.

8. The visual search server according to claim 6, wherein the affinity scores are normalized to [0, 1].

9. The visual search server according to claim 6, wherein affinity scores of 0 are assigned to non-active cluster pairs.

10. The visual search server according to claim 6, wherein Linear Discriminant Analysis is employed to determine a sorted vector of the affinity scores used to obtain the global descriptor for the query image.

11. A method, comprising:
transmitting a visual search request containing information relating to a global descriptor for a query image for a visual search request from a mobile device to a visual search server, wherein the global descriptor for the query image is obtained based on processing including sorting and heat kernel-based transformation; and
receiving, for each of one or more sets of stored image information accessible to the visual search server in which a global descriptor for a respective image corresponds to the global descriptor for the query image, a matching image identification.

12. The method according to claim 11, wherein the global descriptor for the query image is obtained based on affinity scores computed from sorted Hamming distances for cluster pairs.

13. The method according to claim 12, wherein the affinity scores are normalized to [0, 1].

14. The method according to claim 12, wherein affinity scores of 0 are assigned to non-active cluster pairs.

15. The method according to claim 12, wherein Linear Discriminant Analysis is employed to determine a sorted vector of affinity scores used to obtain the global descriptor for the query image.

16. A mobile device, comprising:
a wireless data connection configured
to transmit a visual search request containing information relating to a global descriptor for a query image for a visual search request to a visual search server, wherein the global descriptor for the query image is obtained based on processing including sorting and heat kernel-based transformation, and
to receive, for each of one or more sets of stored image information accessible to the visual search server in which a global descriptor for a respective image corresponds to the global descriptor for the query image, a matching image identification.

17. The mobile device according to claim 16, wherein the global descriptor for the query image is obtained based on affinity scores computed from sorted Hamming distances for cluster pairs.

18. The mobile device according to claim 17, wherein the affinity scores are normalized to [0, 1].

19. The mobile device according to claim 17, wherein affinity scores of 0 are assigned to non-active cluster pairs.

20. The mobile device according to claim 17, wherein Linear Discriminant Analysis is employed to determine a sorted vector of affinity scores used to obtain the global descriptor for the query image.
